(19) United States
(12) Patent Application Publication
(10) Pub. No.: US 2005/0029962 A1
(43) Pub. Date: Feb. 10, 2005

(54) Luminosity adjustable fluorescent lamp device for coordinated use with silicon controlled phase luminosity modulator

(76) Inventor: Foo Onn Fag, Hong Kong Kowloon (CN)

Correspondence Address: DENNISON, SCHULTZ, DOUGHERTY & MACDONALD, 1727 KING STREET, SUITE 105, ALEXANDRIA, VA, 22314, US

(21) Appl. No.: 10/496,316

(22) PCT Filed: Dec. 2, 2002
(86) PCT No.: PCT/EP02/13574

(30) Foreign Application Priority Data
Dec. 5, 2001 (CN) 01 2 69679.X

(51) Int. Cl. H05B 39/04

(52) U.S. Cl. 315/247; 315/291; 315/224

(57) ABSTRACT

Luminosity adjustable fluorescent lamp device available for coordinated use with silicon-controlled phase-luminosity modulator includes a fluorescent lamp (1) and an electric ballast (2), the electric ballast including a filtering and rectifying circuit (21), a luminosity modulating or regulating information abstracting and collating circuit (22) and a frequency control, switch and output circuit (23). The luminosity modulating information is abstracted though the luminosity modulating information abstracting and collating circuit (22) from the input circuit of the fluorescent lamp (1) and collation is conducted to the information to make it become corresponding D.C. potential information which is then delivered to the frequency control, switch and output circuit (23) which conducts frequency modulation to make a working frequency change corresponding to phase modulation angle.

### FIELD OF THE INVENTION

The invention relates to a luminosity adjustable fluorescent lamp device for use in connection with a silicon controlled phase-luminosity modulator to conduct luminosity regulation corresponding to phase angle modulation.

### BACKGROUND OF THE INVENTION

Generally, incandescent lamp bulbs may adopt silicon-controlled phase-luminosity modulators to conduct luminosity regulation. The silicon-controlled phase-luminosity modulator possesses characteristics of simpler circuit, fewer components, low price and sound luminosity regulating effect, hence this kind of luminosity modulator has been popularly applied in incandescent lamp illuminating systems. For this reason, people hoped to apply silicon-controlled phase-luminosity modulators in luminosity modulation or regulation of fluorescent lamps, however, it is regrettable that since during working of fluorescent lamp tubes and circuits, there is a certain demand on waveform of input power source and mode of luminosity regulation, hence when using conventional silicon-controlled phase-luminosity modulators—known as TRIAC dimmers—to conduct directly luminosity modulation for fluorescent lamps, the fluorescent lamps will blink, leading to luminosity regulation out of control and service life of the lamps subject to severe influence. As a result, recently there is attempt to seek for conducting technical renovation to working circuits of fluorescent lamps, so as to improve the luminosity modulation on fluorescent lamps, however, there is not yet any sound solution so far and the problem of luminosity modulation of fluorescent lamps has become a technical barrier to puzzle the continual development of fluorescent lamps.

Lately, there appears on the market a luminosity adjustable fluorescent lamp. Although it can achieve the object of luminosity modulation, however, it suffers from numerous drawbacks, complicated circuit, high cost, low reliability and its product is unable to be well popularized on the market.

From U.S. Pat. No. 5,792,619 there is known a switching mode d.c. current regulator for controlling the current and the luminosity of one or more filament lamps. The current regulator includes a current sensor as actual value transmitter of the current for the lamps, a console for providing the current set point and a pulse width modulator. The output of the pulse width modulator is connected to a FET switch. The FET switch supplies a pulsating modulated current via an inductor and the current sensor to the lamp. Therefore, the current to the lamp is a pulsating direct current.

There is also known an IC driver in ballasts for fluorescent lamps. The driver is connected to a floating transistor of a symmetric half-bridge inverter (Application Note SGS Thomson XP 0022 36717 www.eetasia.com/articles/2000jun16-and-8.pdt.)

From DE-A-30 14 419, there is known a ballast for a fluorescent lamp. An electric capacitor is connected in parallel to the fluorescent lamp.

An object of the invention is to overcome the above-mentioned drawbacks and to design a novel luminosity adjustable fluorescent lamp device for use in connection with a silicon-controlled phase-luminosity modulator, that device, when used in connection with a silicon-controlled phase-luminosity modulator, can abstract luminosity modulating information, conduct simplification and collate to the abstracted information to convert it into frequency modulation, and simultaneously to make working frequency change corresponding to phase modulation angle, so as to attain stable luminosity-modulation of fluorescent lamp.

### SUMMARY OF THE INVENTION

According to the invention this object is achieved in a luminosity adjustable fluorescent lamp device for use in connection with a silicon-controlled phase-luminosity modulator to conduct luminosity regulation corresponding to phase angle modulation in that the luminosity adjustable fluorescent device comprises a fluorescent lamp and a ballast that comprises: A wave filtering and rectifying circuit to convert input A.C. into D.C. through filtering and rectification; a luminosity regulating or modulating information abstracting and collating circuit which is in electric connection with output terminal of said wave filtering and rectifying circuit for acquiring smooth rectangular wave whose widths corresponds to the modulated phase angle by said silicon controlled phase-luminosity modulator and for filtering and integrating said rectangular wave to become a D.C. potential signal which corresponds to the modulated phase angle by said silicon controlled phase-luminosity modulator; and a frequency control, switch and output circuit which is connected with its input terminal with output terminal of said luminosity regulating or modulating information abstracting and collating circuit and is provided with a voltage controlled oscillator and a series connecting switch output circuit which is in electric connection with one terminal of two cathodes of said fluorescent lamp through an inductor, a diode and electric capacitors respectively and changes its working frequency corresponding to the adjustable phase angle of said silicon controlled phase-luminosity modulator to decrease the fluorescent lamp tube power when its working frequency is rising.

In the above-mentioned luminosity adjustable fluorescent lamp device, said luminosity regulating or modulating information abstracting and collating circuit comprises a comparison circuit and a wave filtering and integrating circuit, wherein, the comparison circuit is composed of a voltage divider, a comparator, a diode and several resistor, said voltage divider comprises a first resistor and a second resistor which are connected to two output terminals of the filtering and rectifying circuit after being connected in series, input terminal of the comparator is connected with the middle joint point of the first and second resistors, input terminal of the comparator is connected with the series connection joint point of one of the several resistors and terminal P of the diode, output terminal of said comparator is connected with a second one of the several resistors, the filtering and integrating circuit comprises a resistor and a capacitor, the input terminals of which are connected with output terminal of the comparator through a resistor of the filtering and integrating circuit.

In the above mentioned luminosity adjustable fluorescent lamp device, the voltage-controlled oscillator is composed of a resistor, a capacitor and a diode and the series connecting such output circuit is composed mainly of field effect transistors and electric inductor, wherein the input terminal of the voltage-controlled oscillator is in electric connection with the output terminal of the filtering integrating circuit and controls an integrated circuit to generate and output follow-up oscillating frequency waveform; the field effect transistors of the series connecting switch output circuit are connected with the output terminal of the filtering integrating circuit through the integrated circuit and resistors and are in electric connection through the electric inductor, the diode and the electric capacitors respectively.

In the above-mentioned luminosity adjustable fluorescent lamp device, said fluorescent lamp comprises further an electric capacity, each of two terminals of that electric capacity is connected to other terminal of two cathodes of said fluorescent lamp tube.

It is obvious from the above, the luminosity adjustable fluorescent lamp device of the invention provides an electronic ballast device, that device comprises: A filtering and rectifying circuit, a luminosity regulating or modulating information abstracting and collating circuit and a frequency control, switch and output circuit. Since the luminosity modulating information abstracting and collating circuit abstracts luminosity adjusting information on the input circuit of the fluorescent lamp and conducts collating to information to make it become a corresponding D.C. potential information, and the information is then delivered to the frequency control, switch and output circuit to conduct frequency modulation to make working frequency change corresponding to phase modulation angle. The change of frequency makes power supply to the fluorescent lamp tube descends or ascends correspondingly, so as to attain the object of luminosity regulation, and moreover, there are also advantages of fewer components, low cost high reliability and consequently ease to popularization.

### BRIEF DESCRIPTION OF THE ACCOMPANYING DRAWINGS

FIGS. 1a and 1b are plan views of regular waveform output when load being a pure resistance, for instance when load being an incandescent lamp, and silicon-controlled phase-luminosity modulator being under two kinds of phase modulating angle;

FIG. 2 is a plan view of complicated waveform output from a silicon-controlled phase-luminosity modulator when load being a fluorescent lamp;

FIG. 3 is a plan view of abrupt change of waveform likely to occur when phase angle of a silicon-controlled phase-luminosity modulator is adjusted near to 90 degrees;

FIG. 4 is a block diagram of the luminosity adjustable fluorescent lamp device according to an embodiment of the invention;

FIG. 5 is a circuit diagram of the embodiment of the luminosity adjustable fluorescent lamp device of FIG. 4;

FIG. 6 is the waveform output after through comparison and filtering integrating circuit of FIG. 5, which is a highly smooth rectangular waveform and the width of that rectangular waveform is corresponding to phase angle of silicon-controlled luminosity modulation.

### DETAILED DESCRIPTION OF A PREFERRED EMBODIMENT OF THE INVENTION

Referring to FIG. 5, a luminosity adjustable fluorescent lamp device for use in connection with a silicon-controlled phase-luminosity modulator comprises a fluorescent lamp 1, characterized in that it further comprises an electronic blast 2, that ballast comprises:

A filtering and rectifying circuit 21 which comprises inductor L1, a capacitor C1, a voltage-sensitive resistor RV, a bank of bridge type rectifying diode B1 and a capacitor C2, so as to convert input A.C. into D.C. through filtration and rectification;

A luminosity regulating or modulating information abstracting and collating circuit 22, which comprises a comparison and a filtering integrating circuit, wherein the comparison circuit is composed of a voltage divider, a comparator LM, a diode D7 and several resistors R3, R4, the voltage divider comprises a first resistor R1 and a second resistor R2, which are connected, after being connected in series, to two output terminals of the filtering and rectifying circuit, input terminal 2 of the comparator LM is connected with the middle point of the first and second resistors, input terminal 3 of the comparator LM is connected to the series connection joint point of one resistor R3 of the several resistors and terminal P of a diode D7, output terminal 1 of the comparator LM is connected with a second resistor R4 of the several resistors, the filtering integrating circuit comprises a resistor R5 and a capacitor C5, whose input terminal is connected with output terminal 1 of comparator LM through resistor R5 for acquiring smooth rectangular wave with width corresponding to phase angle of luminosity modulator. A frequency control, switch and output circuit 23, which comprises a voltage-controlled oscillator composed of resistor R9, capacitor C6, Diode D10 and a series connection switch output circuit mainly composed of transistors Q1, Q2 and inductor L2, wherein, the voltage-controlled oscillator input terminal is in electric connection with output terminal of filtering integrating circuit through a diode D9, and controls an integrated circuit IC to generate and output follow-up rectangular oscillating frequency waveform, the field effect transistors Q1, Q2 of switch output circuit are connected with the output terminal of filtering integrating circuit through integrated circuit IC and resistors R11 and R12, and are in electric connection respectively with one terminal b, d of two cathodes of fluorescent lamp tube 11 through the inductor L2, diode D6 and electric capacitors C11, C12.

Said fluorescent lamp comprises further an electric capacitor C10, each of two terminals of that electric capacitor C10 is connected to other terminal a, c of two cathodes of the fluorescent lamp tube 11.

The working principle of luminosity adjustable fluorescent lamp device of the invention is described as follows:

The realization of luminosity regulation is through abstracting luminosity modulating information on input circuit of fluorescent lamp 1, and conducting information collating to change it into corresponding D.C. potential information, then delivering it to frequency modulating circuit to make working frequency change corresponding to phase modulation angle. Due to change of frequency, the power supplied to fluorescent lamp tube 11 also makes corresponding descent or ascent, so as to attain luminosity regulation object.

The filtering and rectifying circuit 21 is to convert A.C. input form municipal power supply network into D.C., as an input information sampling position of fluorescent lamp device, the luminosity regulating information abstracting and collating circuit 22 ought to be positioned after the filtering and rectifying circuit 21 in fluorescent lamp circuit, the object is to acquire fully the positive directional output waveform of silicon-controlled phase-luminosity modulator. This information passes through the voltage divider composed of the first resistor R1 and the second resistor R2 of comparison circuit of luminosity modulating information abstracting and collating circuit 22, a signal of which enters into input terminal 2 of comparator LM, so as to conduct a comparison. The input terminal 3 threshold comparison voltages of comparator LM is set rather low, the diode voltage drop of diode D7 is taken as comparison voltage, about 0.6 V, i. e. equal to or less than 0.6 V. Thus, although when waveform of input information is complicated, but the complicated information wave over 0.6 V will be eliminated. The output waveform, after comparison, will be highly smooth rectangular wave, while the waveform width will be corresponding to phase angle of silicon-controlled luminosity modulator, as shown in FIG. 6.

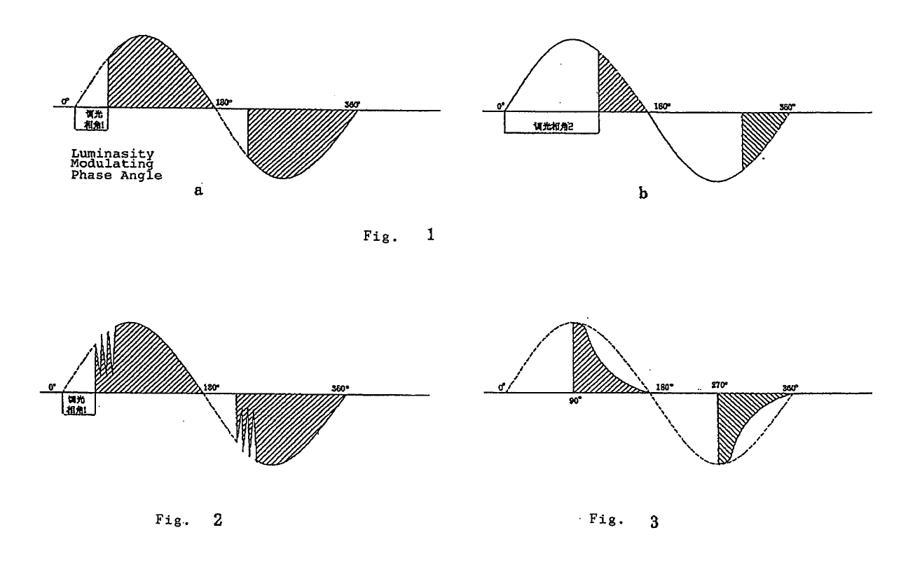

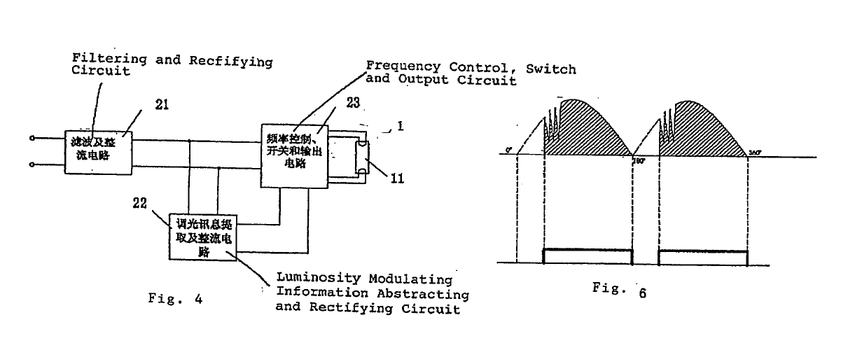

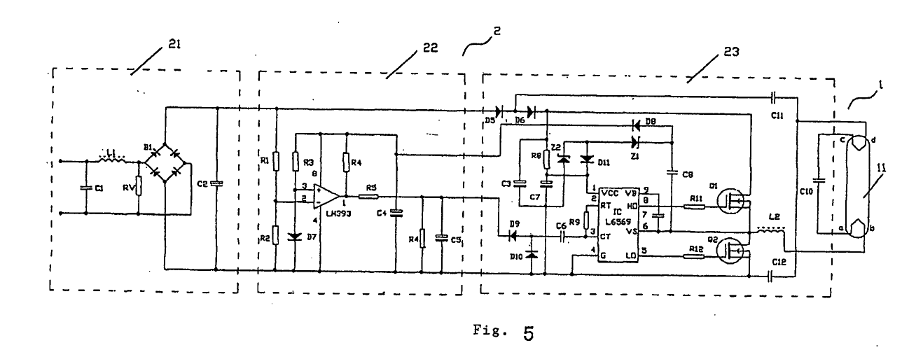

Why is the luminosity adjusting information abstracting and collating circuit 22 positioned after the filtering and rectifying circuit 21 in fluorescent lamp circuit? Firstly, the output waveform of silicon-controlled phase-luminosity modulator depends highly on its load. When the load is pure resistance, for instance, when load is an incandescent lamp, the waveform is fully regular as shown in FIG. 1. However, when the load is a fluorescent lamp, then its output waveform will become very complicated, as shown in FIG. 2. When the phase angle of silicon-controlled phase-luminosity modulator is nearly to 90 degrees, there will be an abrupt change of waveform, as shown in FIG. 3; next, in case the luminosity modulating information is abstracted on the silicon-controlled phase-luminosity modulator, then additional conductor wire should be fitted to the fluorescent lamp, and it is very difficult in practice, therefore the abstract of information can only be made at the input terminal of the fluorescent lamp. However, the waveform abstracted form that input terminal will be very complicated, the waveform integration cannot acquire even and stable data value corresponding to phase modulation. When delivering out this kind of unstable information, the fluorescent lamp will blink seriously and the luminosity regulation will be seriously uneven.

For this reason, we have designed a luminosity modulating information abstracting and collating circuit 22 composed of a comparator LM and the relevant circuits which can give stable and even substracted information, the fluorescent lamp 11 will not blink and luminosity regulation will be even and steady. The output waveform information at terminal 1 of comparator LM, after being filtered and integrated by R5 and C5 of filtering integrating circuit, will become a D.C. potential signal. This potential signal is also corresponding to the phase angle of the silicon-controlled phase-luminosity modulator. This information in turn is delivered to voltage-controlled oscillator of R9, C6, D10 and integrated circuit IC, etc. through D9 to generate follow-up oscillating frequency waveform. Then, the voltage-controlled oscillator delivers the oscillating frequency waveform trough resistors R11 and R12 connected at terminals HO and VS of integrated circuit IC to switch filed effect transistor Q1, Q2 circuit to control the working frequency of switch transistor, and through electric inductor L2, diode D6 and electric capacitors C11, C12 respectively delivers it to two cathodes of the fluorescent lamp tube 11, so as to attain: When the phase angle of the silicon-controlled phase-luminosity modulator changes, the working frequency of fluorescent lamp 1 will make corresponding change.

In order to acquire wider luminosity adjusting range, however, the signal output from terminal 1 of comparator LM should be made to have a larger changing range. Generally, the power supply voltage of the comparator is lower than 10V, under this condition it is very difficult to acquire output signal to have larger changing range. For this reason, we raise the power supply voltage to the comparator. At present, the power supply voltage adopted is 30 V, this will be feasible to acquire large enough signal changing range, and the luminosity regulation range can be realized in an extremely large extent from 100% down to 10%.

The descending of the input power of the fluorescent lamp 1 and the temperature compensation of the cathode of fluorescent tube 11 during the luminosity regulation or modulation will be described in the following: Since luminosity modulation is attained through frequency change, hence at the time without luminosity modulation, i. e. the fluorescent lamp 1 being at the highest brightness, its working frequency is the lowest, at the time of luminosity modulation, its working frequency will be raised corresponding to the gradual increase of phase angle θ of silicon-controlled phase-luminosity modulator. At the time of maximum phase angle θ, the working frequency is also the highest, now the fluorescent lamp 1 is at the lowest brightness.

In the output circuit of fluorescent lamp 1, there is provided an electric inductor L2 functioning as a ballast, for the purpose of enabling fluorescent lamp 1 to work steadily. The inductive reactance of electric inductor L2 increases with the rise of frequency. Hence at the time of luminosity regulation, i. e. when frequency is rising, the inductive reactance of inductor L2 follows to increase. Thus the power delivered to lamp tube 11 will drop. Due to drop of input power of lamp tube 11, the luminosity of lamp tube also drops, thereby the object of luminosity regulation is obtained.

Generally, the cathode of fluorescent lamp tube 11 is designed for hot cathode working, hence the lamp tube when working must have a certain temperature, otherwise cathode will be damaged very soon. The cathode temperature relies on ion bombardment and electric current flowing through cathode. However, when input power of lamp tube 11 drops, temperature acquired from ion bombardment also drop. However, now the electric capacity C10 connected across two ends of cathode filament a, c will have its capacity reactance to drop due to the rise of the working frequency which increases current flowing through that cathode lamp filament, so as to compensate for the above-mentioned temperature drop to enable the cathode of lamp tube still to work normally.

1. A luminosity adjustable fluorescent lamp device available for coordinated use with silicon-controlled phase-luminosity modulator comprises fluorescent lamp, characterized in that it comprises further an electronic ballast, that electronic ballast comprises:
A wave filtering and rectifying circuit (21) to convert input A. C. into D. C. through filtering and rectification;
A luminosity regulating or modulating information abstracting and collating circuit (22) with input terminal being in electric connection with output terminal of said filtering and rectifying circuit (21) for acquiring smooth rectangular wave with width corresponding to phase angle of a luminosity modulator;
A frequency control, switch and output circuit (23), with its input terminal being in electric connection with output terminal of said luminosity modulating or regulating information abstracting and collating circuit (22), its output terminal being in electric connection to said fluorescent lamp (1) to modulate working frequency to make the working frequency change corresponding to angle of phase modulation; and
Said fluorescent lamp (1) being in electric connection with output terminal of the frequency control, switch and output circuit (23) and with the help of its output frequency change to control the descent and ascent of fluorescent lamp tube power.

2. A luminosity adjustable fluorescent lamp device available for coordinated use with silicon-controlled phase-luminosity modulator according to claim 1, characterized in that said luminosity modulating information abstracting and collating circuit (22) comprises a comparison circuit, a filtering and integrating circuit, wherein, the comparison circuit is composed of a voltage divider, a comparator (LM), a diode (D7), and several resistors (R3, R4), said voltage divider comprises a first resistor(RI) and a second resistor (R2), which after being connected in series, are connected to two output terminals of the filtering and rectifying circuit (21), input terminal (2) of the comparator (LM) is connected with the middle joint point of the first resistor (R1) and second resistor (R2), input terminal (3) of said comparator (LM) is connected with the series connecting joint point of one resistor (R3) of said several resistors and terminal (P) of said diode (D7), output terminal (1) of said comparator (LM) is connected with another resistor (R4) of said several resistors; the filtering integrating circuit comprises a resistor(R5) and a capacitor(C5) whose input terminal is connected with output terminal (1) of said comparator (LM) through an resistor (R5).

3. A luminosity adjustable fluorescent lamp device available for coordinated use with silicon-controlled phase-luminosity modulator according to claim 1, characterized in that the frequency control, switch and output circuit (23) comprises a voltage-controlled oscillator composed of a resistor (R9), a capacitor (C6), a diode(D10) and a series connecting switch output circuit composed mainly of field effect transistors(Q1, Q2) and electric inductor (L2), wherein the input terminal of voltage-controlled oscillator input terminal is in electric connection with the output terminal of the filtering integrating circuit and controls an integrated circuit(IC) to generate and output follow-up oscillating frequency waveform; said field effect transistors(Q1, Q2) of switch output circuit are connected with the output terminal of filtering integrating circuit through an integrated circuit (IC) and resistors(R11 and R12), and are in electric connection with one terminal (b, d) of two cathodes of fluorescent lamp tube (11) trough an electric inductor (L2), a diode (D6) and electric capacitors (C11, C12) respectively.

4. A luminosity adjustable fluorescent lamp device available for coordinated use with silicon-controlled phase luminosity modulator according to claim 1, characterized in that said fluorescent lamp (1) comprises further an electric capacitor (C10), each of two terminals of that electric capacitor (C10) is connected to other terminal (a, c) of two cathodes of the fluorescent lamp tube (11).

5. A luminosity adjustable fluorescent lamp device available for coordinated use with silicon-controlled phase-luminosity modulator according to claim 1, characterized in that the power supply voltage of said comparator (LM) is over 10 V.

6. A luminosity adjustable fluorescent lamp device available for coordinated use with silicon-controlled phase luminosity modulator according to claim 1, characterized in that the voltage drop of said diode (D7) is equal to or less than 0.6 V.
